(19) United States
(12) Patent Application Publication
(10) Pub. No.: US 2016/0072188 A1
(43) Pub. Date: Mar. 10, 2016

(54) COMPACT MINIATURE HIDDEN ANTENNAS FOR MULTI FREQUENCY BANDS APPLICATIONS

(71) Applicants: Basim Alkhateeb, Irbid Sama Alrousan (JO); Abualkhair M. Alkhateeb, Auburn Hills, MI (US)

(72) Inventors: Basim Alkhateeb, Irbid Sama Alrousan (JO); Abualkhair M. Alkhateeb, Auburn Hills, MI (US)

(73) Assignee: KING ABDULLAH II DESIGN AND DEVELOPMENT BUREAU, Amman (JO)

(21) Appl. No.: 14/481,130

(22) Filed: Sep. 9, 2014

(51) Int. Cl. H01Q 9/14; H01Q 9/06

(52) U.S. Cl. CPC H01Q 9/145; H01Q 9/065

(57) ABSTRACT

Disclosed is a compact antenna assembly and a method for making an antenna that is adapted to receive radio waves within the 200 MHz-2800 Mhz frequency band. The antenna assembly includes a meander line antenna trace of a desired geometry having a plurality of bends and strips that is configured to reduce the effect of electromagnetic interference. The antenna trace is placed on a dielectric substrate that is configured to receive the antenna trace along a surface thereon. At least one break point element is positioned along the meander line antenna trace wherein the at least one break point element is configured to be positioned along the antenna trace at various locations to adjust a resonant frequency of the antenna assembly according to the desired application.

### BACKGROUND

The present exemplary embodiment relates to a compact miniature antenna. It finds particular application in conjunction with hidden antennas for multi frequency band applications, and will be described with particular reference thereto. However, it is to be appreciated that the present exemplary embodiment is also amenable to other like applications.

Generally, small printed meander line antenna is a good candidate for single and multi-frequency applications. The following patent documents are hereby incorporated by reference in their entirety. These documents include:

U.S. Pat. No. 7,742,005 to Villarroel et al.; U.S. Pat. No. 6,731,020 to Burr et al.; U.S. Pat. No. 6,417,810 to Huels et al.; U.S. Pat. No. 5,027,128 to Blaese; U.S. Pat. No. 6,593,897 to McConnell; U.S. Pat. No. 5,900,841 to Hirata et al.; U.S. Pat. No. 6,820,314 to Ferguson et al.; U.S. Pat. No. 6,639,559 to Okabe et al.; and U.S. Pat. No. 6,339,404 to Johnson et al.

Additionally, the following non-patent documents are also incorporated by reference in their entirety and include: [1] J. Lee and S. Park, “The Meander Line Antenna for Bluetooth,” Microwave and Optical Technology Letters, Vol. 34, No. 2, pp. 149-151, July 2002. [2] G. Marrocoo, “Gain-optimized Self-resonant Meander Line Antennas for RFID Applications,” IEEE Trans. Antennas Wireless Propagation Letters, Vol. 2, No. 1, pp. 302-305, 2003, [3] R. Azadegan and K. Sarabandi, “A Compact Folded Dipole Antenna for Wireless Applications,” in Proc. IEEE Antennas Propagation Symp., Columbus, Ohio, pp. 439-442, June 2003, [4] K. Wong, T. Tseng, F. Hsiao, and T. Chiu, “High Gain Omnidirectional Printed Collinear Antenna,” Microwave and Optical Technology Letters, Vol. 44, No. 4, pp. 348-351, 2005, [5] K. Rao, P. Nikitin, and S. Lam, “Antenna Design for UHF RFID Tags: A Review and A Practical Application,” IEEE Trans. On Antennas and Propagation, Vol. 53, No. 12, pp. 3870-3876, 2005, [6] M. Keskilammi, M. Kivikoski, “Using Text as A Meander Line for RFID Transponder Antennas,” IEEE Antennas and Propagation Letters, Vol. 3, pp. 372-374, 2004, [7] T. Williams, M. Rahman, and M. Stuchly, “Dual Band Meander Antenna for Wireless Telephones,” Microwave and Optical Technology Letters, Vol. 24, No. 2, pp. 81-85, 2000, [8] S. Fujio, T. Asano, and M. Tsumita, “Small Dual Band Modified Antenna with Multiple Elements,” IEEE Antennas Propagation Symp., July 2005, [9] H. Chen, “Triple-band Triangular-shaped Meander Monopole Antenna with Two Coupled Lines,” Microwave and Optical Technology Letters, Vol. 37, No. 3, pp. 232-234, May 2003, [10] J. Wu, C. Lin, and J. Lu, “A planar Meander Line Antenna for Triple Band Operation of Mobile Handsets,” Microwave and Optical Technology Letters, Vol. 41, No. 5, pp. 380-386, 2004, and [11] G. Lee and K. Wong, “Quad Band Internal Monopole Mobile Phone Antenna,” Microwave and Optical Technology Letters, Vol. 40, No 5, pp. 359-361, 2004.

Generally, an embedded antenna is printed on a dielectric board together with electronic components related to the desired application. These applications include Bluetooth, radio frequency identification (RFID), wireless local area networks (WLAN), wireless telephones, remote keyless entry (RKE) systems and other communication devices. Small printed meander line antenna applications have been used with both active and passive antenna applications that operate in the 300 MHz frequency range. Additionally, meander line antennas are known to operate in the 2.4 GHz WLAN band.

In one instance, there have been experiments for a meander line antenna to be utilized in applications operating in 869 MHz which is a typical European frequency for RFID devices. Additionally, experiments have been conducted with dual band meander line antennas that operate in 824-894 MHz for the advanced mobile phone system (AMPS) as well as in applications between 2 GHz and 5 GHz frequency bands. Further, triple band meander line antennas and quad band meander mobile phone antenna designs have been used with the AMPS/GSM (824-864/890-960 MHz) and the DCS/PCS (1710-1880/1850-1990 MHz) application bands.

Planar printed meander line miniature antenna is a promising design for extended range automotive applications such as RKE systems. The meander line antenna can achieve high efficiency with very small size. Small size asymmetrical external antennas printed on FR4 dielectric antenna for interior application has been investigated in the technical paper by B. Al-Khateeb, V. Rabinovich, and B. Oakley, An active receiving antenna for short-range wireless automotive communication, Microwave and Optical Technology Letters, Vol. 43, No. 4, pp. 293-297, November 2004 which is also incorporated by reference herein in its entirety. It was shown that a suggested geometry induces significant current flow by utilizing an outer conductor of the RF cable that connects an antenna with an RKE control module.

The various uses of miniature antennas require that they be located near many different electronic devices that produce parasitic near-field emissions which interfere with the signal received by the antenna. The interference reduces signal strength and the communication range of the antenna. Additionally, many meander line antennas are require to be configured in vastly different topologies to exhibit the optimum gain experienced along the resonant frequency spectrum as is desired for a particular application. The particular meander line shape or topology that is optimal for use with various applications along various frequency range applications is inefficient to manufacture or produce on a large scale.

Therefore, there remains a need for an antenna system and method that utilizes a printed meander antenna having a particular topology that can be easily adapted for use with various applications along a broad frequency spectrum. Further, it is desirable to provide an antenna assembly with a small size that can avoid unwanted reduction in communication ranges commonly caused by known systems and methods of radio frequency communication.

### BRIEF DESCRIPTION

In one embodiment, the present disclosure discloses a compact antenna assembly that is adapted to receive radio waves within the 200 MHz-2800 Mhz frequency band. The antenna assembly includes a meander line antenna trace of a desired geometry having a plurality of bends and strips that is configured to reduce the effect of electromagnetic interference. The antenna trace is placed on a dielectric substrate that is configured to receive the antenna trace along a surface thereon. At least one break point element is positioned along the meander line antenna trace wherein the at least one break point element is configured to be positioned along the antenna trace at various locations to adjust a resonant frequency of the antenna assembly according to the desired application.

In another embodiment, disclosed is a method of adapting a compact antenna assembly to receive a desired band of radio waves within the 200 MHz-2800 Mhz frequency band, the method includes the steps of providing a meander line antenna trace of a particular geometry having a plurality of bends and strips that is configured to reduce the effect of electromagnetic interference. The meander line antenna trace is positioned along a surface of a dielectric substrate. A desired length of the meander line antenna trace is identified for a desired application. A break point element is positioned along the meander line antenna trace such that the location of the break point element along the meander line antenna trace adjusts a resonant frequency of the antenna assembly according to the desired application.

### BRIEF DESCRIPTION OF THE DRAWINGS

The present disclosure may take form in certain parts and arrangements of parts, several embodiments of which will be described in detail in this specification and illustrated in the accompanying drawings which form a part hereof and wherein:

FIG. 1 is a plan view of an asymmetrical meander dipole antenna of the prior art;

FIG. 2 is a graph of a simulated versus measured results of the meander dipole antenna of FIG. 1 in the 200-2800 MHz frequency band;

FIG. 3 is a plan view of one embodiment of the meander dipole antenna of the present disclosure;

FIG. 4 is a graph of measured results of a voltage standing wave ratio of one embodiment of the meander dipole antenna of FIG. 3 of the present disclosure;

FIG. 5 is a graph of measured results of a voltage standing wave ratio of one embodiment of the meander dipole antenna of FIG. 3 of the present disclosure; and

FIG. 6 is a graph of measured results of a voltage standing wave ratio of one embodiment of the meander dipole antenna of FIG. 3 of the present disclosure.

### DETAILED DESCRIPTION

It is to be understood that the detailed figures are for purposes of illustrating exemplary embodiments of the present disclosure only and are not intended to be limiting. Additionally, it will be appreciated that the drawings are not to scale and that portions of certain elements may be exaggerated for the purpose of clarity and ease of illustration.

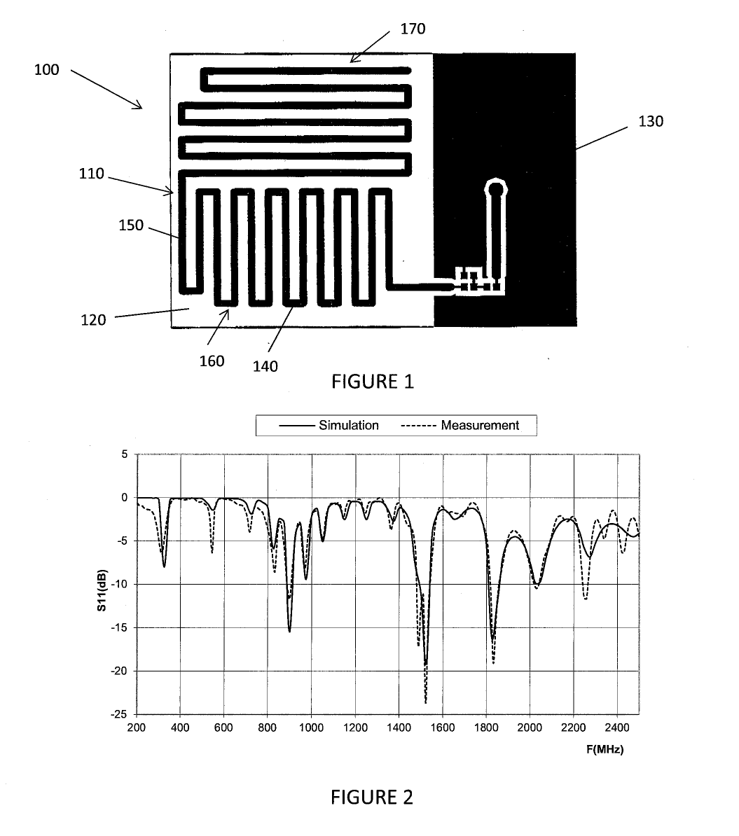

The antenna shown in FIG. 1 is an example of a meander antenna. The antenna of FIG. 1 can be modified to resonate at different frequency bands.

The antenna 100 of FIG. 1 has been constructed and measured in a very wide frequency range from 200 MHz up to 2800 MHz and can be used in many short range applications. The antenna 100 includes a plurality of bends and strips and is printed on a dielectric board. The dielectric board is configured to be housed within the interior portions of the various electronic devices that can be hidden from view. Disclosed are various antenna geometries including an asymmetrical meander line antenna. The antenna is generally asymmetrical because it includes one meander trace that does not include a generally similar shaped meander trace positioned along an opposite portion of the dielectric board.

FIG. 1 illustrates the meander line antenna 100 that includes a meander line antenna trace 110 made of a conductive material that is printed on one side of a dielectric substrate 120 such as a FR4 type substrate. In one embodiment, the dielectric substrate includes a thickness of about 1.6 mm and a relative permittivity of about 4.4. The width of the meander line antenna trace is approximately 1 mm. The antenna 100 presented in FIG. 1 includes a ground spot 130 which can be used as a ground for an amplifier circuit when the antenna is used with an active receiving design. The unoccupied spaces on the dielectric substrate 120 can be used to include electronic components for an active antenna design (such as an amplifier circuit, components to digitize the signal, etc.). Additionally, this unoccupied space can include a receiving circuit that is configured to receive a demodulated signal.

The total printed meander line length includes a plurality of bends 140 and strips 150. The asymmetrical meander antenna trace includes a trace arm 160 and a trace projection 170 that extends from the trace arm 160. The trace arm 160 in this embodiment includes twelve (12) bends 140 and twelve (12) strips 150 of the antenna trace 110. The trace projection 170 extends from the last bend of the trace arm 160 and includes six (6) bends 140 and seven (7) strips 150. The trace projection 170 is positioned adjacent the trace arm 160 and each are received substantially along the dielectric substrate 120. The number of bends 140 and the length for each strip 150 for the antenna 100 has been selected using electromagnetic software IE3D by Zeland. IE3D is an electromagnetic 3D modeling program.

FIG. 2 identifies the simulation results versus actual measured results of the voltage standing wave ratio (VSWR) measurements of the antenna of FIG. 1. FIG. 2 shows the simulation results using software program IE3D. VSWR is a measure that numerically describes how well an antenna's impedance matches to an associated radio or transmission line impedance. VSWR can also be seen as a measure of how much power is delivered to an antenna. A value of less than about 2 dB is generally sufficient measurement for VSWR. FIG. 2 illustrates a satisfactory agreement between the simulated and the measured results. Notably, s11 (dB) is indicative of a reflection coefficient. These results show that the meander antenna 100 of FIG. 1 has many resonant frequencies (for example, between 800 MHz and 1000 MHz, between 1400 MHz and 1600 MHz and between 1800 MHz and 2000 MHz). This reflects the performance of this antenna within these resonance frequency ranges.

Note that antenna 100 could be used for the following applications: Remote keyless entry (RKE) for automotive applications which fall in the 315 MHz frequency band; radio frequency identification (RFID) applications in North America and Mexico in about the 902-928 MHz frequency band; L-band digital radio in Canada in about the 1452-1492 MHz frequency band; digital communications system (DCS)/personal communications system (PCS) in about 1850-1990 MHz/1800-1900 MHz frequency bands; WLAN application fields with within about the 2400-2484 MHz frequency band; and many other applications (bluetooth, cellular, wireless bar code readers, wireless microphones, etc.).

Measurement results show that changes to the length of the meander antenna trace 110 of antenna 100 can be made to vary the resonant frequency without having to design or provide a separate antenna topology.

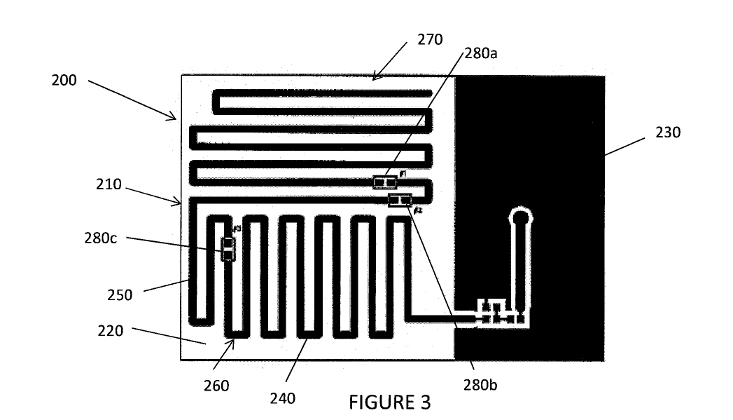

FIG. 3 illustrates a meander line antenna 200 with linear sizes of various lengths and widths. In one embodiment, the antenna 200 include a meander line antenna trace 210 that is made of a conductive material that is printed on one side of a dielectric substrate 220 such as a FR4 type substrate. In one embodiment, the dielectric substrate includes a thickness of about 1.6 mm and a relative permittivity of about 4.4. The width of the meander line antenna trace is approximately 1 mm. Antenna 200 presented in FIG. 3 include a ground spot 230 which can be used as a ground for an amplifier circuit when the antenna is used with an active receiving design. The unoccupied spaces on the dielectric substrate 220 can be used to include electronic components for an active antenna design (such as an amplifier circuit, components to digitize the signal, etc.). Additionally, this unoccupied space can include a receiving circuit that is configured to receive a demodulated signal.

The total printed meander line length includes a plurality of bends 240 and strips 250. The asymmetrical meander antenna trace includes a trace arm 260 and a trace projection 270 that extends from the trace arm 260. The trace arm 260 in this embodiment includes twelve (12) bends 240 and twelve (12) strips 250 of the antenna trace 210. The trace projection 270 extends from the last bend of the trace arm 260 and includes six (6) bends 240 and seven (7) strips 250. The trace projection 270 is positioned adjacent the trace arm 260 and each are received substantially along the dielectric substrate 220.

The number of bends 240 and the length for each strip 250 for each antenna has been selected using electromagnetic software IE3D.

FIG. 3 illustrates a meander line antenna 200 with break point elements 280a, 280b and 280c that have about 0Ω measurements such as a jumper or a zero ohm resistor. The break point elements 280a, 280b and 280c in this embodiment are break points positioned along the meander line antenna 210 at various positions. The position of each break point element is specifically identified based from measurements and analysis technique to specify the location of this breaking point. The break point elements 280a, 280b, and 280c modify the length and/or geometry of the trace line 210 to allow the antenna 200 to be adjusted for use with a specific application according to the desired resonant frequency of the intended application. Notably, zero ohm resistors can have a general range of Ω measurements that are close to but not absolute zero Ω. These measurements can range between 0-100 mΩ or more particularly, about 0-10 mΩ. In FIG. 3, the break point elements 280a, 280b, 280c are located in specific predetermined positions. However, this disclosure is not limited as to the number or location of the break point elements along the antenna trace. Additionally, other antenna trace geometries could be utilized with this

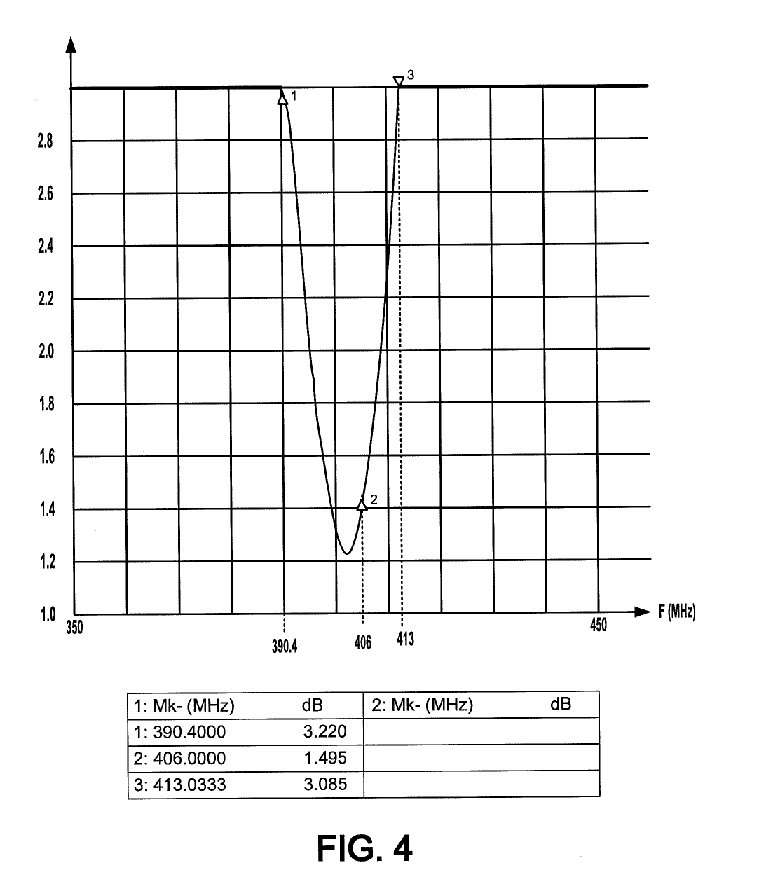

In one embodiment, break point element 280a is removed from the meander line 210. In this case, the antenna resonates at a frequency of about 406 MHz which is desirable for Search and Rescue Satellite-Aided Tracking systems (SARSAT). The VSWR measurement of the meander antenna with break point element 280a removed wherein break point elements 280b and 280c remain is illustrated by FIG. 4. With this modification, the VSWR value becomes 1.495 dB at the frequency 406 MHz. This value indicates an intended resonance frequency, tuned for use with a performable application antenna such as a Cospass-SAR Satellite.

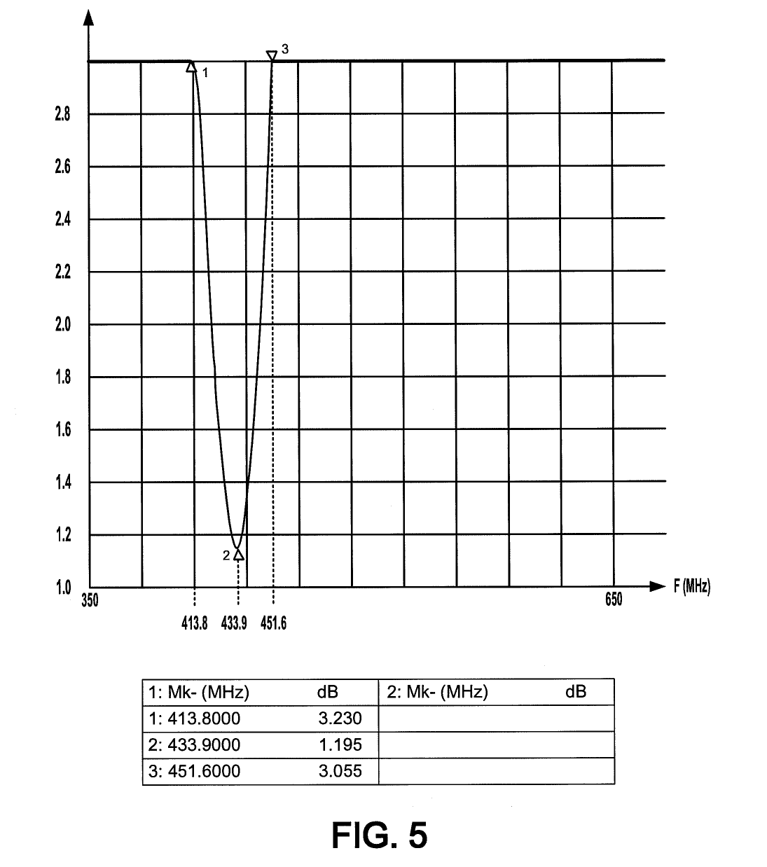

In another embodiment, break point element 280b is removed from the meander line 210. In this case, the antenna resonates at a frequency of about 433.9 MHz having a VSWR value of about 1.195 dB which is desirable for a remote keyless entry (RKE) frequency for certain automotive applications. The VSWR measurement of the meander antenna with break point element 280b removed wherein break point elements 280a and 280c remain is illustrated by FIG. 5.

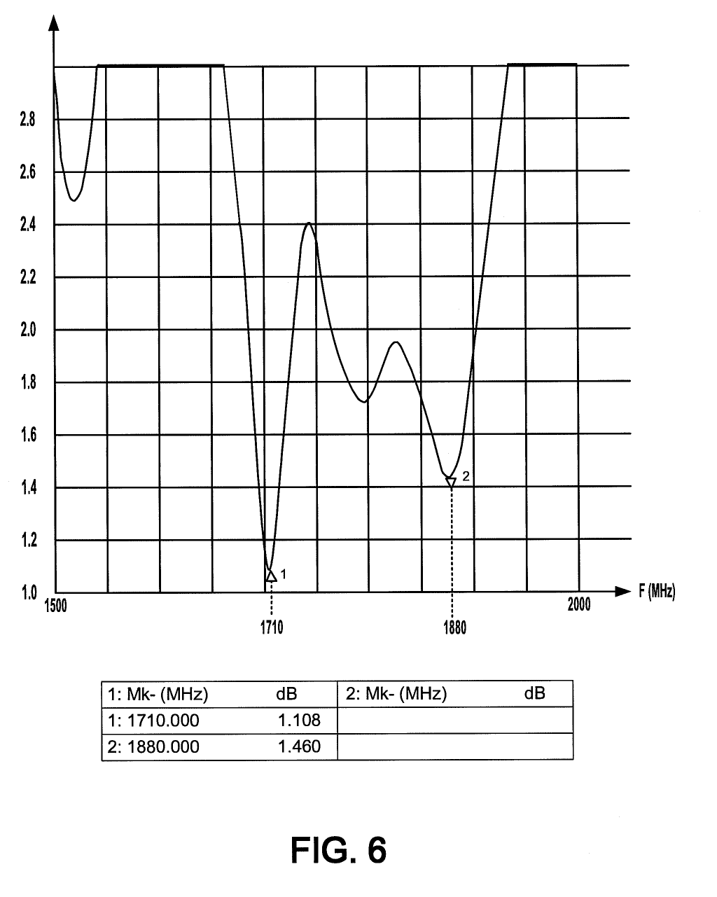

In yet another embodiment, break point element 280c is removed from the meander line 210. In this case, the antenna resonates in a frequency range of about 1710-1880 MHz which is desirable for DCS applications. The VSWR measurement of the meander antenna with break point element 280c removed wherein break point elements 280a and 280b remain is illustrated by FIG. 6. The corresponding curve for the VSWR of this embodiment is below 2 dB and is therefore optimum for both frequencies 1710 MHz and 1880 MHz which confirms the validity of this antenna design for this frequency range.

The research revealed that meander antennas have minimum VSWR fluctuations within allowable tolerances. These tolerances can be estimated R, L, C tuned values and can perform as a transmission line of the lumped matching elements. (ie. the RLC matching values) Consequently, small size (about 6×4 cm) meander line antennas have very stable tolerances, do not require low quality inductors in the matching circuits, and are preferable in production processes.

Also disclosed is a method of adapting the compact antenna assembly 200 to receive a desired band of radio waves within the 200 MHz-2800 Mhz frequency band to a particular desired application by adding break point elements thereon. The method includes providing a meander line antenna trace 210 of a particular geometry having a plurality of bends 240 and strips 250 that is configured to reduce the effect of electromagnetic interference. The meander line antenna trace is positioned along a surface of a dielectric substrate. A desired geometry or topology identified of the meander line antenna trace 210 is identified for a desired application.

At least one break point element 280a-280c is positioned along the meander line antenna trace 210 such that the location of the break point element along the meander line antenna trace 210 adjusts a resonant frequency of the antenna assembly according to the desired application.

Based on the matched agreement between the measured and the simulated results, the optimum VSWR below about 2 dB, the multi-resonance frequency, and the ease of redesign with minor and minimal modifications, the meander line antenna 110, is dependable, reliable and versatile. It can be used with a wide range of different communication systems that demand different frequencies with the addition of break point elements 280 positioned along various locations of the antenna trace.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A compact antenna assembly that is adapted to receive radio waves within the 200 MHz-2800 Mhz frequency band, the antenna assembly comprising:
a meander line antenna trace of a desired geometry having a plurality of bends and strips that is configured to reduce the effect of electromagnetic interference; and
a dielectric substrate is configured to receive the antenna trace along a surface thereon; and
at least one break point element positioned along the meander line antenna trace;
wherein the at least one break point element is configured to be positioned along the antenna trace at various locations to adjust a resonant frequency of the antenna assembly according to an associated application.

2. The compact antenna assembly according to claim 1 wherein the geometry of the meander line antenna trace is configured in an asymmetrical orientation.

3. The compact antenna assembly according to claim 1 wherein the at least one break point element is positioned along the antenna trace at a first position such that the antenna is configured to receive radio waves at about the 315 MHz frequency band.

4. The compact antenna assembly according to claim 1 wherein the at least one break point element is positioned along the antenna trace at a second position such that the antenna is configured to receive radio waves within about the 902-928 MHz frequency band.

5. The compact antenna assembly according to claim 1 wherein the at least one break point element is positioned along the antenna trace at a third position such that the antenna is configured to receive radio waves within about the 1452-1492 MHz frequency band.

6. The compact antenna assembly according to claim 1 wherein the at least one break point element is positioned along the antenna trace at a fourth position such that the antenna is configured to receive radio waves within about the 1850-1990 MHz frequency band.

7. The compact antenna assembly according to claim 1 wherein the at least one break point element is positioned along the antenna trace at a fifth position such that the antenna is configured to receive radio waves within about the 1800-1900 MHz frequency band.

8. The compact antenna assembly according to claim 1 wherein the at least one break point element is positioned along the antenna trace at a sixth position such that the antenna is configured to receive radio waves within about the 2400-2484 MHz frequency band.

9. The compact antenna assembly according to claim 2 wherein the asymmetrical meander dipole antenna includes a trace arm and a trace projection that extends from the trace arm substantially along the dielectric substrate.

10. The compact antenna assembly according to claim 1 wherein the dielectric substrate is a FR-4 type dielectric substrate.

11. The compact antenna assembly according to claim 1 wherein the meander line antenna trace has a width that is approximately 1 mm.

12. The compact antenna assembly according to claim 1 further comprising a ground spot that is configured to be used as an amplifier circuit.

13. The compact antenna assembly according to claim 1 wherein the at least one break point element is a space along the meander line antenna trace that has a resistance of approximately 0Ω.

14. A compact antenna assembly that is adapted to receive radio waves within a 200 MHz-2800 Mhz frequency band, the antenna assembly comprising:
a meander line antenna trace of a desired geometry with a generally asymmetrical orientation having a plurality of bends and strips that is configured to reduce the effect of electromagnetic interference; and
a dielectric substrate includes a length (L) and a width (W) that is configured to receive the antenna trace along a surface thereon; and
at least two break point elements positioned along the meander line antenna trace;
wherein the at least one break point element is configured to be positioned along the antenna trace at various locations to adjust a resonant frequency of the antenna assembly according to an associated application.

15. The compact antenna assembly according to claim 14 wherein the at least one break point element is a space along the meander line antenna trace that has a resistance of approximately 0Ω.

16. The compact antenna assembly according to claim 14 wherein the resonant frequency is adjusted to one of the following frequency bands: 315 MHz, within 902-928 MHz, within 1452-1492 MHz, within 1850-1990 MHz, within 1800-1900 MHz, and within 2400-2484 MHz.

17. The compact antenna assembly according to claim 14 wherein the asymmetrical meander dipole antenna includes a trace arm and a trace projection that extends from the trace arm substantially along the dielectric substrate.

18. A method of adapting a compact antenna assembly to receive a desired band of radio waves within the 200 MHz-2800 Mhz frequency band, the method comprising:
providing a meander line antenna trace of a particular geometry having a plurality of bends and strips that is configured to reduce the effect of electromagnetic interference;
positioning the meander line antenna trace along a surface of a dielectric substrate includes; and
identifying a desired length of the meander line antenna trace for a desired application;
positioning a break point element along the meander line antenna trace such that the location of the resistor along the meander line antenna trace adjusts a resonant frequency of the antenna assembly according to the desired application.

19. The method of claim 18 further comprising the step of positioning a second break point element along the meander line antenna trace.

20. The method of claim 19 further comprising the step of positioning a third break point element along the meander line antenna trace.
